(19) United States
(12) Patent Application Publication
(10) Pub. No.: US 2016/0319073 A1
(43) Pub. Date: Nov. 3, 2016

(54) ALKYLENE OXIDE-FREE METHODS FOR PRODUCING POLYETHEROLS

(71) Applicant: BASF SE, Ludwigshafen (DE)

(72) Inventors: Eva-Maria REIS-WALTHER, Breuberg (DE); Hoang Trang TRAN-THIEN, Paderborn (DE); Roland BOU CHEDID, Dubai (AE); Frank MRZENA, Neustadt (DE); Roman B. RAETHER, Speyer (DE)

(21) Appl. No.: 15/102,589

(22) PCT Filed: Dec. 1, 2014
(86) PCT No.: PCT/EP2014/076103

§ 371 Date: Jun. 8, 2016

(30) Foreign Application Priority Data
Dec. 10, 2013 (EP) 13196526.1

(51) Int. Cl. C08G 65/34

(52) U.S. Cl. CPC C08G 65/34

(57) ABSTRACT

The present invention relates to methods for the alkylene oxide-free preparation of compositions comprising polyetherols using one or more alkylene carbonates as reactants. The polyetherol compositions prepared according to the invention ideally do not comprise carbonate or comprise almost no carbonate. The present invention also comprises the use of alkylene carbonate for preparing polyetherols or compositions comprising polyetherols and polyetherols or compositions comprising polyetherols prepared by the method according to the invention.

The present invention relates to methods for the alkylene oxide-free preparation of compositions comprising polyetherols using one or more alkylene carbonates as reactants. The polyetherol compositions prepared according to the invention ideally do not comprise carbonate or comprise almost no carbonate. The present invention also comprises the use of alkylene carbonate for preparing polyetherols or compositions comprising polyetherols and polyetherols or compositions comprising polyetherols prepared by the method according to the invention.

In the course of preparation of polyetherols such as polyethylene glycols, ethylene oxide (EO) is typically polymerized by means of alkaline catalysis (Ullmann's Encyclopedia of Industrial Chemistry, Vol. 35, 469-479). This method, however, has the disadvantage that EO as starting material is not available everywhere. Alternative methods in which an alkylene carbonate (AC) such as ethylene carbonate (EC) is polymerized instead of EO have the disadvantage that carbonates are incorporated here in the polyetherol chains. (Patil, J Scientific Industrial Res (2005), 64: 364-366). Further methods in which alkylene carbonates are polymerized (inter alia to provide alcohol alkoxylates) are known, where a high carbonate content in the respective product can be assumed (RO 113141 B; WO 00/21913).

These technical problems are solved by the subject matter according to the invention, which is provided and described below and in the claims.

The present invention relates to a method for preparing polyetherol compositions using alkylene carbonates as reactants in which the compositions prepared are free or almost free of carbonates. In particular, ethylene carbonate and propylene carbonate, inter alia, may be mentioned in the context of the present invention as examples of alkylene carbonates.

The present invention particularly relates to a method for preparing compositions comprising polyetherols comprising the following steps:

(a) mixing a starter alcohol with a catalyst;

(b) heating the mixture from (a) to 220 to 300° C.;

(c) adding an alkylene carbonate (AC) to the mixture from (b) in a ratio of alkylene carbonate:

OH groups of the starter alcohol of 50:1 to 1:1 at an addition rate of 0.3 to 3.5 mol of alkylene carbonate/mol of OH groups of the starter alcohol/hour;

(d) cooling the mixture from (c) to 20 to 100° C.; and

(e) neutralizing the mixture from (d).

With respect to the alkylene carbonate in step (c) of the method according to the invention or in connection with the use according to the invention, any alkylene carbonate can in principle be used. In one embodiment in the scope of the present invention, the alkylene carbonate to be deployed or to be used is ethylene carbonate, propylene carbonate or glycerol carbonate, preferably ethylene carbonate.

In the scope of the present invention it has been found, surprisingly, that the carbonate content ultimately present in the polyetherol composition prepared can be drastically reduced by suitable choice of parameters such as reaction temperature, reaction pressure, concentration of catalyst and addition rate of alkylene carbonate to the starter alcohol. Without being bound to one theory, it is assumed that the reaction in progress proceeds preferably according to scheme 1 below by suitable choice of the parameters stated, while the undesired side reaction according to scheme 2 is inhibited.

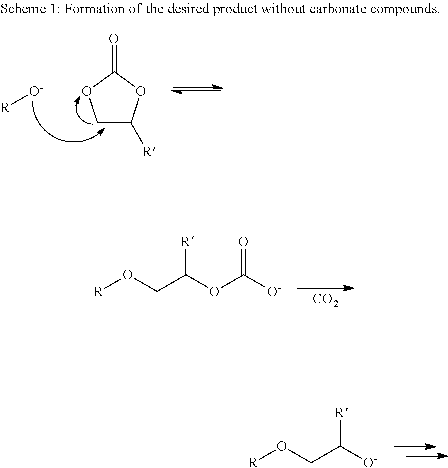

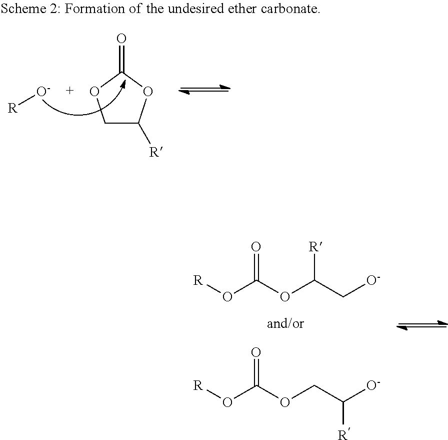

When the preparation of polyetherols is referred to below, this is in principle synonymous with the preparation of polyetherol compositions, unless otherwise explicitly described or is clearly evident to those skilled in the art (e.g. the isolation of polyetherols from the composition prepared).

The carbonate content (i.e. the proportion of carbonate-containing compounds in the scope of the present invention) in the composition prepared by the method according to the invention is preferably not higher than 10 mol %, preferably not higher than 7 mol %, particularly preferably not higher than 1.5 mol %, measured as the mixture from (e). In the context of the present invention, the carbonate content (i.e. the proportion of carbonate-containing compounds in the scope of the present invention) of the composition prepared is preferably measured by ¹H-NMR, as is generally known to those skilled in the art and as exemplified here; see Hesse, Meier, Zeeh, Spektroskopische Methoden in der organischen Chemie (Spectroscopic methods in organic chemistry), 1995, Chapter 3. “Carbonate content” is understood to mean, in the context of the present invention, the proportion of carbonate-containing functional groups in the polyetherol composition prepared, unless explicitly stated otherwise.

The starter alcohol in step (a) of the method according to the invention in principle includes any suitable alcohol. In the scope of the present invention, preference is given to linear or branched C₁ to C₃₀ alcohols, aliphatic or aromatic diols and polyols. Particularly preferred in this connection are C₄ to C₁₈ linear alcohols, C₄ to C₁₈ branched alcohols, monoethylene glycol, diethylene glycol, or polypropylene glycol having 1 to 60 propylene units. Most preferred in the context of the present invention is monoethylene glycol, and C₄ to C₁₈ linear or branched alcohols.

The catalyst in step (a) of the method according to the invention in principle includes any suitable catalyst although double metal cyanide (DMC) catalysts and basic catalysts are preferred. In one embodiment of the present invention, the catalyst is selected from the group consisting of DMC catalysts, alkali metal bases, amines and imidazoles, preferably from the group consisting of alkali metal bases, amines and imidazoles, particularly preferably alkali metal bases. Examples of alkali metal bases can be KOH, NaOH, CsOH, KOMe, and KOtBu, as is known to those skilled in the art. In this connection, the concentration of the catalyst in accordance with the invention is important, particularly since excessively low catalyst concentrations may lead to increased carbonate contents (cf example 1). In the scope of the present invention, for example, 0.1 to 5% by weight, preferably 0.1 to 3% by weight, particularly preferably 0.1 to 1% by weight of catalyst may be used, measured in each case as the total weight of the composition from step (c) of the method of the present invention.

The heating in step (b) of the method according to the invention can be conducted at 220 to 300° C., preferably at 220 to 280° C., particularly preferably at 220 to 260° C., 230 to 260° C. or 240 to 260° C. At excessively low temperatures, the carbonate content of the polyetherol composition to be prepared according to the invention is increased to an undesirable degree (cf example 2). Ideally, the alkylene carbonate in step (c) of the method according to the invention is added immediately after reaching the desired temperature.

After reaching the desired temperature in step (b) of the method according to the invention, alkylene carbonate (e.g. ethylene carbonate, propylene carbonate or glycerol carbonate) is added. In this connection, the rate of alkylene carbonate addition is important according to the invention. The ratio of alkylene carbonate: OH groups of the starter alcohol can be, in accordance with the invention, 50:1 to 1:1, preferably 40:1 to 1:1. preferably 30:1 to 1:1, particularly preferably 10:1 to 1:1. The addition rate, in accordance with the invention, can be 0.3 to 3.5 mol of alkylene carbonate per mole of OH groups of the starter alcohol per hour, preferably 0.5 to 2 mol of alkylene carbonate per mole of OH groups of the starter alcohol per hour, particularly preferably 0.7 to 1.4 mol of alkylene carbonate per mole of OH groups of the starter alcohol per hour. The absolute pressure during the addition can be, inter alia, 0.5 to 10 bar, preferably 0.7 to 5 bar, particularly preferably 0.8 to 1.2 bar.

Overall, it has been discovered in the context of the present invention, that the relevant parameters such as reaction temperature, reaction pressure, concentration of the catalyst and addition rate of alkylene carbonate to the starter alcohol can influence the resulting carbonate content of the polyetherol composition prepared or to be prepared, both collectively and independently of one another. For instance, the influence of the addition rate of alkylene carbonate to the starter alcohol with respect to the carbonate content at a reaction temperature of ca. 220° C. is thus proportionally less than at a reaction temperature of ca. 260° C. At an elevated reaction temperature (here: 260° C. as against 220° C.; cf examples 3 and 4) however, the resulting carbonate content in the polyetherol composition is lower overall.

In one embodiment, the alkylene carbonate in the method according to the invention is added as a melt, as is generally known to those skilled in the art.

The alkylene carbonate in step (c) of the method according to the invention or the use according to the invention in principle includes any suitable alkylene carbonate. In the context of the present invention, ethylene carbonate, propylene carbonate and glycerol carbonate are preferred. Most preferred in the context of the present invention is ethylene carbonate.

The cooling of the mixture in step (d) of the method according to the invention after the addition of the alkylene carbonate can be carried out actively or passively although in the context of the present invention an active cooling is preferred. The mixture can be cooled, in accordance with the invention, to 20 to 100° C., preferably to 30 to 80° C., particularly preferably to 40 to 60° C.

The resulting mixture from step (d) is subsequently neutralized in a manner known to those skilled in the art. Non-limiting examples of neutralizing agents suitable in this connection comprise organic or inorganic acids such as acetic acid, lactic acid, phosphoric acid or ion exchangers such as Ambosol® (PQ Corporation, USA). In the course of this, an isolation or purification of the polyetherols from the composition prepared in accordance with the invention is also possible in a manner known to those skilled in the art.

In one form of the method according to the invention, small amounts of halides are used. Since halides, inter alia, may also occur as constituents of primarily basic catalysts, these should also be considered in connection with the present invention in the determination of halide use or halide content. Without being bound to any. one theory, halides in the reaction mixture may lead to decomposition of ethylene carbonate into ethylene oxide and CO_{2.} Both substances then escape the reaction mixture in gaseous form which under certain circumstances can lead to an undesired low molecular weight. In the context of the present invention, therefore, it is desirable if the catalysts used, optionally basic catalysts used, comprise no or only very little halides.

The term “halides” in the context of the invention comprises both isolated halides, which are directly added during the course of the method according to the invention (or before), and those halides which are added as constituents or impurities of other components such as catalysts in step (a) of the method according to the invention. In this connection, such small amounts of halides (as compound or as ions) are used in the overall process for example, such that their total proportion in the mixture from step (c) of the method according to the invention is not more than 50 ppm by weight, preferably not more than 5 ppm by weight, particularly preferably not more than 1 ppm by weight. In this connection, it is the same whether small amounts of halides were added or are removed over the course of the method or thereafter, in order to achieve the proportions cited. The halide fraction may be determined in a manner known to those skilled in the art, preferably, in accordance with the invention, by elemental analysis as described, inter alia, in Ullmann's Encyclopedia of Industrial Chemistry; Vol. 3; Chapter 6.4, p. 402.

Polyetherols are in principle not limited in connection with the present invention. Polyetherols may comprise, according to the invention, inter alia, polyalkylene glycols (PAG), methyl polyalkylene glycols (mPAG) and surfactants. In this connection, polyethylene glycol (PEG), for example, is suitable as polyalkylene glycol and methyl polyethylene glycol (mPEG), for example, should be mentioned as methyl polyalkylene glycol. Preference is given to PEG in the context of the present invention.

As examples of alkylene carbonate in the embodiments according to the invention below, ethylene carbonate, propylene carbonate or glycerol carbonate should be mentioned, preferably ethylene carbonate.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 Co 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;

(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d).

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d), wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units; and
wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d).

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d).

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is selected from the group consisting of C₄ to C₁₈ linear alcohols, C₄ to C₁₈ branched alcohols, monoethylene glycol, diethylene glycol, polypropylene glycol having 1 to 60 propylene units; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol.

The present invention particularly relates to a method for preparing compositions comprising polyetherols comprising the following steps:
(a) mixing a starter alcohol with a catalyst;
(b) heating the mixture from (a) to 220 to 300° C. preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d).

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate; OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol.

The present invention particularly relates to a method for preparing compositions comprising polyetherols comprising the following steps;
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate; OH groups of the starter alcohol of 30:1 to 1:1 at an addition rate of 0.3 to 3,5 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d).

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d).

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 50:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 300° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol; and

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d).

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the catalyst is an alkali metal base.

The present invention particularly relates to a method for preparing compositions comprising polyetherols comprising the following steps:
(a) mixing a starter alcohol with a catalyst;
(b) heating the mixture from (a) to 220 to 260° C., preferably 240 to 260° C.;
(c) adding alkylene carbonate to the mixture from (b) in a ratio of alkylene carbonate: OH groups of the starter alcohol of 30:1 to 1:1 at an addition rate of 0.7 to 1.4 mol of alkylene carbonate/mol of OH groups of the starter alcohol/hour;
(d) cooling the mixture from (c) to 20 to 100° C.; and
(e) neutralizing the mixture from (d),

wherein the starter alcohol is polyethylene glycol; and

wherein the catalyst is an alkali metal base.

The present invention further relates to the use of alkylene carbonate for preparing polyetherols or compositions comprising these. In this connection, ethylene carbonate, propylene carbonate or glycerol carbonate, for example, should be mentioned as alkylene carbonates. Preference is given to ethylene carbonate.

The present invention further relates to polyetherols or compositions comprising these which are prepared or are preparable by the method according to the invention as provided and described here.

The present invention is further elucidated and illustrated by means of the examples below, but without being restricted to them.

### EXAMPLES

### Example 1

### Variation of the Amount of Catalyst

a) comparative example: A 1 L jacketed reactor was charged with 62 g (1.0 mol) of ethylene glycol and 0.20 g of an aqueous potassium hydroxide solution (50% by weight) at 50° C. and the water was removed at <20 mbar. The reactor was then flushed with nitrogen and the temperature increased to 220° C. Over the course of 3 h, 678 g (7.7 mol) of ethylene carbonate were added (corresponding to an addition rate of 1.3 mol of ethylene carbonate/mol of OH group/hour). The reaction mixture obtained was then stirred for 2 h at 220° C. and, after cooling to room temperature, was neutralized with Ambosol®. 319 g of a colorless liquid were obtained with a carbonate content of 11.9 mol % measured by ¹H-NMR according to Hesse, Meier, Zeeh, Spektroskopische Methoden in der organischen Chemie (Spectroscopic Methods in Organic Chemistry), 1995, Chapter 3.
b) A 1 L jacketed reactor was charged with 62 g (1.0 mol) of ethylene glycol and 2.0 g of an aqueous potassium hydroxide solution (50% by weight) at 50° C. and the water was removed at <20 mbar. The reactor was then flushed with nitrogen and the temperature increased to 220° C. Over the course of 3 h, 678 g (7.7 mol) of ethylene carbonate were added (corresponding to an addition rate of 1.3 mol of ethylene carbonate/mol of OH group/hour). The reaction mixture obtained was then stirred for 2 h at 220° C. and, after cooling to room temperature, was neutralized with Ambosol®. 365 g of a yellow liquid were obtained with a carbonate content of 6.8 mol % measured by ¹H-NMR according to Hesse, Meier, Zeeh, Spektroskopische Methoden in der organischen Chemie (Spectroscopic Methods in Organic Chemistry), 1995, Chapter 3.

| | Amount of KOH | |
|---|---|---|
| | [% based on end | Carbonate |
| | product] | [%] |
| a | 0.05 | 11.9 |
| b | 0.5 | 6.8 |

### Example 2

### Variation of the Temperature

c) comparative example: A 1 L jacketed reactor was charged with 62 g (1.0 mol) of ethylene glycol and 2.0 g of an aqueous potassium hydroxide solution (50% by weight) at 50° C. and the water was removed at <20 mbar. The reactor was then flushed with nitrogen and the temperature increased to 200° C. Over the course of 3 h, 678 g (7.7 mol) of ethylene carbonate were added (corresponding to an addition rate of 1.3 mol of ethylene carbonate/mol of OH group/hour). The reaction mixture obtained was then stirred for 2 h at 200° C. and, after cooling to room temperature, was neutralized with Ambosol®. 350 g of a brown liquid were obtained with a carbonate content of 12.3 mol % measured by ¹H-NMR according to Hesse, Meier, Zeeh, Spektroskopische Methoden in der organischen Chemie (Spectroscopic Methods in Organic Chemistry), 1995, Chapter 3.
d) A 1 L jacketed reactor was charged with 62 g (1.0 mol) of ethylene glycol and 2.0 g of an aqueous potassium hydroxide solution (50% by weight) at 50° C. and the water was removed at <20 mbar. The reactor was then flushed with nitrogen and the temperature increased to 260° C. Over the course of 3 h, 678 g (7.7 mol) of ethylene carbonate were added (corresponding to an addition rate of 1.3 mol of ethylene carbonate/mol of OH group/hour). The reaction mixture obtained was then stirred for 2 h at 260° C. and, after cooling to room temperature, was neutralized with Ambosol®. 318 g of a brown liquid were obtained with a carbonate content of 1.1 mol % measured by ¹H-NMR according to Hesse, Meier, Zeeh, Spektroskopische Methoden in der organischen Chemie (Spectroscopic Methods in Organic Chemistry), 1995, Chapter 3.

| | Temperature | Carbonate |
|---|---|---|
| | [° C.] | [%] |
| c | 200 | 12.3 |
| d | 260 | 1.1 |

### Example 3

### Variation of the Addition Rate (at 220° C.)

e) comparative example: A 1 L jacketed reactor was charged with 62 g (1.0 mol) of ethylene glycol and 2.0 g of an aqueous potassium hydroxide solution (50% by weight) at 50° C. and the water was removed at <20 mbar. The reactor was then flushed with nitrogen and the temperature increased to 220° C. Over the course of 1 h, 678 g (7.7 mol) of ethylene carbonate were added (corresponding to an addition rate of 3.9 mol of ethylene carbonate/mol of OH group/hour). The reaction mixture obtained was then stirred for 2 h at 220° C. and, after cooling to room temperature, was neutralized with Ambosol®. 338 g of a yellow liquid were obtained with a carbonate content of 10.7 mol % measured by ¹H-NMR according to Hesse, Meier, Zeeh, Spektroskopische Methoden in der organischen Chemie (Spectroscopic Methods in Organic Chemistry), 1995, Chapter 3.
f) A 1 L jacketed reactor was charged with 62 g (1.0 mol) of ethylene glycol and 2.0 g of an aqueous potassium hydroxide solution (50% by weight) at 50° C. and the water was removed at <20 mbar. The reactor was then flushed with nitrogen and the temperature increased to 220° C. Over the course of 3 h, 678 g (7.7 mol) of ethylene carbonate were added (corresponding to an addition rate of 1.3 mol of ethylene carbonate/mol of OH group/hour). The reaction mixture obtained was then stirred for 2 h at 220° C. and, after cooling to room temperature, was neutralized with Ambosol®. 365 g of a yellow liquid were obtained with a carbonate content of 6.8 mol % measured by ¹H-NMR according to Hesse, Meier, Zeeh, Spektroskopische Methoden in der organischen Chemie (Spectroscopic Methods in Organic Chemistry), 1995, Chapter 3.

| | Addition rate | Carbonate |
|---|---|---|
| | [mol/mol OH/h] | [%] |
| e | 3.9 | 10.7 |
| f | 1.3 | 6.8 |

### Example 4

### Variation of the Addition Rate (at 260° C.)

g) A 1 L jacketed reactor was charged with 62 g (1.0 mol) of ethylene glycol and 2.0 g of an aqueous potassium hydroxide solution (50% by weight) at 50° C. and the water was removed at <20 mbar. The reactor was then flushed with nitrogen and the temperature increased to 260° C. Over the course of 3 h, 678 g (7.7 mol) of ethylene carbonate were added (corresponding to an addition rate of 1.3 mol of ethylene carbonate/mol of OH group/hour). The reaction mixture obtained was then stirred for 2 h at 260° C. and, after cooling to room temperature, was neutralized with Ambosol®. 318 g of a brown liquid were obtained with a carbonate content of 1.1 mol % measured by ¹H-NMR according to Hesse, Meier, Zeeh, Spektroskopische Methoden in der organischen Chemie (Spectroscopic Methods in Organic Chemistry), 1995, Chapter 3.
h) A 1 L jacketed reactor was charged with 62 g (1.0 mol) of ethylene glycol and 2.0 g of an aqueous potassium hydroxide solution (50% by weight) at 50° C. and the water was removed at <20 mbar. The reactor was then flushed with nitrogen and the temperature increased to 260° C. Over the course of 6 h, 678 g (7.7 mol) of ethylene carbonate were added (corresponding to an addition rate of 0.6 mol of ethylene carbonate/mol of OH group/hour). The reaction mixture obtained was then stirred for 2 h at 260° C. and, after cooling to room temperature, was neutralized with Ambosol®. 325 g of a brown liquid were obtained with a carbonate content of 0.2 mol % measured by ¹H-NMR according to Hesse, Meier, Zeeh, Spektroskopische Methoden in der organischen Chemie (Spectroscopic Methods in Organic Chemistry), 1995, Chapter 3.

| | Addition rate | Carbonate |
|---|---|---|
| | [mol/mol OH/h] | [%] |
| g | 1.3 | 1.1 |
| h | 0.6 | 0.2 |

1.-15. (canceled)

16. A method for preparing compositions comprising polyetherols comprising the following steps:
(a) mixing a starter alcohol with a catalyst;
(b) heating the mixture from (a) to 220 to 300° C.;
(c) adding alkylene carbonate to the mixture from (b) in a ratio of alkylene carbonate: OH groups of the starter alcohol of 50:1 to 1:1 at an addition rate of 0.3 to 3.5 mol of alkylene carbonate/mol of OH groups of the starter alcohol/hour;
(d) cooling the mixture from (c) to 20 to 100° C.; and
(e) neutralizing the mixture from (d).

17. The method according to claim 16, wherein the starter alcohol is selected from the group consisting of C₄-C₁₈ linear alcohols, C₄-C₁₈ branched alcohols, monoethylene glycol, diethylene glycol, and polypropylene glycol having 1 to 60 propylene units.

18. The method according to claim 16, wherein the catalyst is selected from the group consisting of alkali metal bases, amines, imidazoles and DMC catalysts.

19. The method according to claim 16, wherein 0.1 to 5% by weight of catalyst is used in step (a), measured as the total weight of the mixture from (c).

20. The method according to claim 16, wherein the mixture in step (b) is heated to 220 to 260° C.

21. The method according to claim 16, wherein the alkylene carbonate in step (c) is added at an addition rate of 0.7 to 1.4 mol of alkylene carbonate/mol of OH groups of the starter alcohol/hour.

22. The method according to claim 16, wherein the absolute pressure during step (c) is 0.5 to 10 bar.

23. The method according to claim 16, wherein not more than 50 ppm by weight of halide is used, measured as the total weight of the mixture from (c).

24. The method according to claim 16, wherein the composition comprises not more than 10 mol % of carbonates, measured as the mixture from (e).

25. The method according to claim 16, wherein the alkylene carbonate is selected from the group consisting of ethylene carbonate, propylene carbonate and glycerol carbonate.

26. The use of alkylene carbonate for preparing polyetherols.

27. A polyetherol composition prepared by the method according to claim 16.

28. The method according to claim 16, wherein the polyetherol is selected from the group consisting of polyalkylene glycol, methyl polyethylene glycol, and surfactant.

29. The method according to claim 28, wherein the polyetherol is a polyalkylene glycol.

30. The method according to claim 29, wherein the polyalkylene glycol is a polyethylene glycol.

31. The method according to claim 16, wherein the mixture in step (b) is heated to 240 to 260° C.

32. The method according to claim 16, wherein the absolute pressure during step (c) is 0.8 to 1.2 bar.

33. The method according to claim 16, wherein the composition comprises not more than 7 mol % of carbonates, measured as the mixture from (e).

34. The method according to claim 16, wherein the composition comprises not more than 1.5 mol % of carbonates, measured as the mixture from (e).
